(19) United States
(12) Patent Application Publication
(10) Pub. No.: US 2021/0206086 A1
(43) Pub. Date: Jul. 8, 2021

(54) DIRECTING GAS BURSTS TO FLOW CONDUITS

(71) Applicant: HEWLETT-PACKARD DEVELOPMENT COMPANY, L.P., Spring, TX (US)

(72) Inventor: David R. OTIS, Jr., Corvallis, OR (US)

(73) Assignee: HEWLETT-PACKARD DEVELOPMENT COMPANY, L.P., Houston, TX (US)

(21) Appl. No.: 16/075,623

(22) PCT Filed: Jul. 14, 2017
(86) PCT No.: PCT/US2017/042109

§ 371 Date: Aug. 4, 2018

(51) Int. Cl. B29C 64/329; B29C 64/393; B33Y 30/00; B33Y 40/00

(52) U.S. Cl. CPC B29C 64/329; B33Y 40/00; B33Y 30/00; B29C 64/393

(57) ABSTRACT

In some examples, a flow conduit transports a material between locations in a three-dimensional (3D) printing system. A controllable valve controls gas communication to the flow conduit. A pressure chamber receives an increase in pressure while the controllable valve is in a restricted flow position, and the controllable valve when actuated to an open position directs a burst of gas at an elevated pressure built up in the pressure chamber to the flow conduit to disturb the material in the flow conduit.

### BACKGROUND

A three-dimensional (3D) printing system can be used to form 3D objects. A 3D printing system performs a 3D printing process, which is also referred to as an additive manufacturing (AM) process, in which successive layers of material(s) of a 3D object are formed under control of a computer based on a 3D model or other electronic representation of the object. The layers of the object are successively formed until the entire 3D object is formed.

### BRIEF DESCRIPTION OF THE DRAWINGS

Some implementations of the present disclosure are described with respect to the following figures.

FIGS. 1 and 2 illustrate arrangements each including a flow conduit and a gas burst injection mechanism, according to various examples.

FIG. 3 illustrates an arrangement that includes a gas-material separator, a hopper, and a gas burst injection mechanism, according to further examples.

FIG. 4 is a top view of a pocket structure including pockets to receive material particles from a hopper, according to alternative examples.

FIG. 5 is a block diagram of a three-dimensional (3D) printing system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the ensuing discussion, use of the terms “above,” “below”, “upper,” and “lower” are to allow for ease of explanation when describing elements in the views shown in various figures. Note that depending on the actual orientation of a device or apparatus, the foregoing terms can refer to other relative arrangements other than being higher or lower along a vertical orientation. Such terms can refer to a diagonal relationship, or to an upside-down relationship (where the terms “above,” “below,” “upper,” and “lower” would be reversed from their ordinary meanings).

In a three-dimensional (3D) printing system, a build material can be used to form a 3D object, by depositing the build material(s) as successive layers on a build platform until the final 3D object is formed. Portions of each layer can be solidified (e.g., fused) to form each layer of the object being printed. In some examples, a build material can include a powdered build material that is composed of particles in the form of fine powder or granules. In other examples, other forms of build materials can be used, such as fiber-based build materials and so forth. The powdered build material can include, for example, metal particles, plastic particles, polymer particles, ceramic particles, or particles of other materials.

The 3D object can be formed on a build platform of the 3D printing system. Build material can be delivered to the build platform using a build material delivery mechanism. Also, build material can be transferred between other locations in the 3D printing system using another build material delivery mechanism (or other build material delivery mechanisms).

A build material delivery mechanism can include a flow conduit, which can be in the form of a hopper in which build material particles can be received at the enlarged portion of the hopper, and directed to a narrow portion of the hopper for delivery to a receiving pocket. The hopper can have various shapes, including a conical shape (or funnel shape), a slot shape (with a rectangular cross section), or any other shape.

In some cases, arching (also referred to as bridging) can occur in the flow conduit, which can block a flow of build material particles (e.g., powder) in the flow conduit. Arching may occur, for example, in response to build material particles being compacted together at a certain location along the flow conduit, such that the compacted build material particles effectively form a barrier to further flow of build material particles.

Although reference is made to a flow of build material particles in some examples, it is noted that in other examples, flow of other types of materials can be performed in a 3D printing system. Techniques or mechanisms according to some implementations of the present disclosure are applicable to flow of such other types of materials through flow conduits.

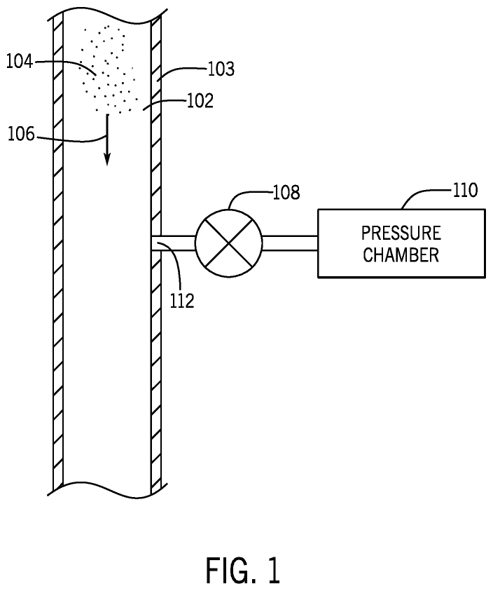

In accordance with some implementations, as shown in FIG. 1, an example arrangement includes a flow conduit 102 to transport particles of a material 104 (which can be in powder form, for example) along a direction 106 between locations in a 3D printing system. As used here, a “flow conduit” can refer to any path along which a material can be transported.

As shown in FIG. 1, the flow conduit 102 is defined by a housing 103. In some examples, the housing 103 can have a tubular shape. In other examples, the housing 103 that defines an inner flow conduit can have a different shape, such as a funnel shape or other shape.

A controllable valve 108 controls gas communication to the flow conduit 102 from a pressure chamber 110. Gas (such as air or some other type of gas) from the pressure chamber 110 is passed through the valve 108 (when the valve 108 is in an open position) to a gas inlet 112 in the housing 103. The gas inlet 112 is in fluidic communication with the valve 108. The gas flows through the gas inlet 112 to the flow conduit 102.

In some examples, the burst of gas enters into the flow conduit 102 through the gas inlet 112 at an angle (e.g., 90° angle or some other non-zero angle) relative to an axial axis of the flow conduit 102, where the axial axis is generally parallel to the direction 106 of material flow.

While the controllable valve 108 is in a restricted flow position (e.g., a closed position or partially open position), pressure in the pressure chamber 110 can be increased by pumping gas into the pressure chamber 110. Although not shown in FIG. 1, a pump can be used to deliver the gas to the pressure chamber 110 to increase the pressure in the pressure chamber 110 while the controllable valve 108 is in the restricted flow position.

The controllable valve 110 when actuated to an open position (e.g., a fully open position or partially open position) directs a burst of gas at an elevated pressure built up in the pressure chamber 110 to the flow conduit 102 to disturb the material 104 in the flow conduit 102. Disturbing the material 104 can include any or some combination of the following caused by blasting or mixing gas with the material 104: fluidizing the material 104, agitating the material 104, and so forth. Fluidizing a material causes the material (in solid form) to acquire characteristics of a fluid by passing a gas through the material. Directing the burst of gas at the elevated pressure increases the velocity at which the gas flows into the flow conduit 102. The velocity of the gas is proportional to the rate of change of the pressure in the pressure chamber 110.

FIG. 2 illustrates another example arrangement. In FIG. 2, a hopper 202 defines an inner flow conduit 203 through which particles of a material 204 can flow. The hopper 202 is shaped generally as a funnel that has an enlarged upper portion 206 with an opening to receive the material 204, and a narrow lower portion 208 through which the material 204 flows to a receiving pocket 210. The receiving pocket 210 is defined inside a pocket support structure. In some examples, the pocket support structure that defines the pocket 210 can be moved to a different location to cause the material 212 received in the pocket 210 to be transported to a different part of a 3D printing system.

FIG. 2 further shows a gas burst injection mechanism 214 to inject a gas burst into the flow conduit 203. The gas burst injection mechanism 214 includes a pump 216, a pressure chamber 218, and a controllable valve 220. In some examples, the controllable valve 220 is a solenoid valve that can be controlled between different settings (closed, partially open, open) by applying electrical signals.

While the valve 220 is in a closed or other restricted flow position, the pump 216 is able to pump a gas into the pressure chamber 218 to increase the pressure in the pressure chamber 218. A pressure sensor 222 can be used to measure the pressure inside the pressure chamber 218.

A controller 224 can receive a measurement from the pressure sensor 222. The controller 224 also provides a control signal to the controllable valve 220, to adjust the valve 220 between different settings. The controller 224 determines, based on the pressure measured by the pressure sensor 222, whether the pressure of the pressure chamber 218 exceeds a specified threshold. If so, the controller 224 can actuate the valve 220 to an open position to cause a burst of gas to be delivered into the flow conduit 203 to disturb the material 204.

In other examples, the controller 224 can actuate the valve 220 in response to a different event (other than a measured pressure). For example, the controller 224 can actuate the valve 220 to the open position after passage of a specified time duration. The controller 224 can use a timer to track an elapsed time, and when the timer expires, the controller 224 can actuate the valve 220 to the open position.

In alternative examples, other events can cause the controller 224 to actuate the valve 220 to the open position to deliver a burst of gas to the flow conduit 203 of the hopper 202. For example, a level sensor 226 can be coupled to the hopper 202 to detect a level of the material 204 in the flow conduit 203. If the level of the material 204 exceeds a specified level, as measured by the level sensor 226, then that can be an indication that the flow conduit 203 is clogged, such as due to arching, such that the valve 220 should be opened to deliver a burst of gas into the flow conduit 203 to disturb the material 204. In such alternative examples, the level sensor 226 can be connected to the controller 224. Based on the level of the material 204 in the flow conduit 203 measured by the level sensor 226, the controller 224 is able to make a decision regarding whether to actuate the valve 220 to an open position.

As used here, a “controller” can refer to a hardware processing circuit, such as a microprocessor, a core of a multi-core microprocessor, a microcontroller, a programmable gate array, a programmable integrated circuit device, or another hardware processing circuit. In other examples, a “controller” can refer to a combination of a hardware processing circuit and machine-readable instructions executable on the hardware processing circuit.

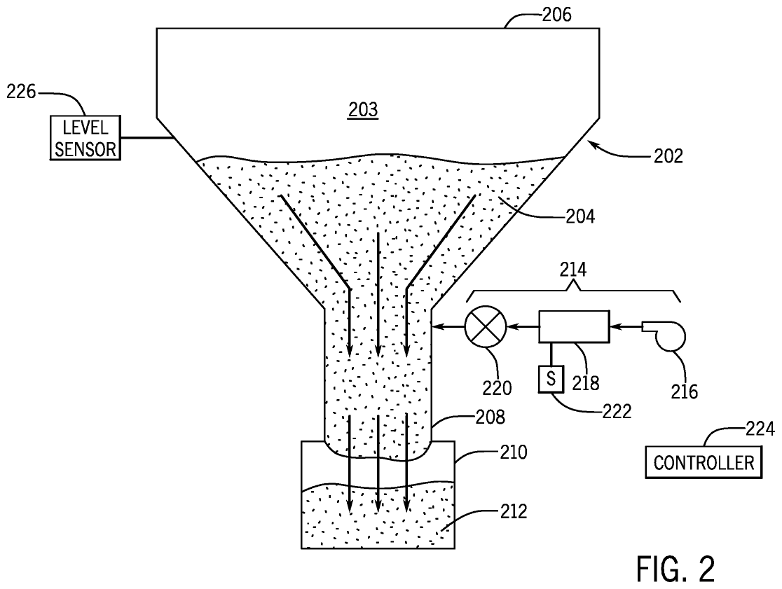

FIG. 3 illustrates another example arrangement that includes a gas-material separator 302 that is used to separate a gas (such as air) from material particles. The gas-material separator 302 is connected to an upper portion of a hopper 304 that is similar to the hopper 202 of FIG. 2.

The separator 302 has an input opening 306 through which a mixture of a gas and material particles can enter into an inner chamber 308 of the separator 302. Material particles flow along a generally spiral path, represented by a dashed path 310 in FIG. 3. A gas (e.g., air) flows along another spiral path that is closer to the central axis of the hopper 304. This gas flow is referred to as a gas vortex, and the flow of gas can exit through an exit gas conduit 314. The separator 302 is referred to as a cyclone separator, since the separation of the gas and material particles is accomplished by flowing a mixture of the gas and material particles along spiral paths. As the mixture of the gas and material particles flows in the spiral paths, the gas (which has a much lower density than the material particles) tends to flow along an exit path 312 to the exit gas conduit 314, and the material particles tend to flow towards the hopper 304. The exit gas conduit 314 transports the separated gas to a target location, where the gas can either be exhaust from the 3D printing system or can be reused.

The separated material particles flow through a lower outlet opening 316 of the separator 302 and into the flow conduit 318 defined inside the hopper 304. The material inside the flow conduit 318 is identified as material 322.

In some examples, a level sensor 320 is connected to the hopper 304 to detect a level of the material 322 inside the flow conduit 318.

The hopper has a gas inlet 326 that is connected to a conduit 324. A burst of gas can flow through the conduit 324 and the gas inlet into the flow conduit 318 of the hopper 304. The burst of gas is provided by a gas burst injection mechanism 328, which is similar to the gas burst injection mechanism 214 shown in FIG. 2.

Once the material 322 has flowed through the flow conduit 318, the material 322 falls through the lower opening 330 of the hopper 304 into a receiving pocket 332 defined by a pocket support structure 334.

A gas burst injection mechanism according to some examples is able to disturb the material 322 in the flow conduit 318, while reducing the amount of gas that is injected into the hopper 304 when compared to continuous aeration systems that tend to deliver too much gas volume into the hopper 304, which can disturb cyclone separation performed by the gas-material separator 302. In addition, gas volume delivered by the gas burst injection mechanism is at high velocity, which can be more effective in disturbing the material 322.

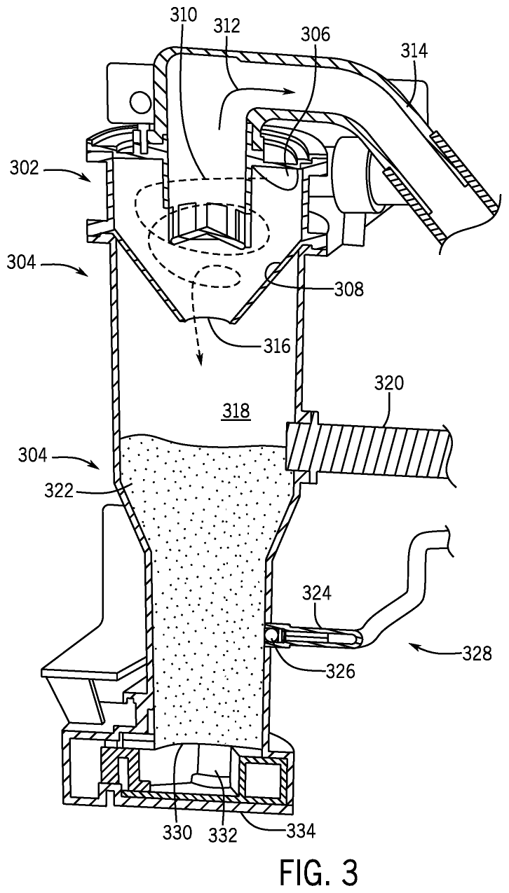

FIG. 4 is a top view of a pocket support structure 402 that defines various pockets 404 for receiving the material 322 received from the hopper 304. The pocket support structure 402 is an example of the pocket support structure 334 used in the arrangement of FIG. 3 or the pocket support structure that defines the pocket 210 of FIG. 2.

As shown in FIG. 4, the lower opening 330 of the hopper 304 is aligned with one of the pockets 404. The pocket structure 402 is rotatable about an axis 406, such that different ones of the pockets 404 can be selectively aligned with the lower opening 330 of the hopper 304. The controller (e.g., the controller 224 of the FIG. 2) can detect a position of a pocket 404 in the pocket support structure 402 relative to the hopper lower opening 330. The controller can actuate the valve (e.g., 108 of FIG. 1 or 220 of FIG. 2) in response to a pocket moving to a predetermined position relative to (e.g., being aligned with) the hopper lower opening 330. In this way, the controller can time the actuation of the delivery of the gas burst into the flow conduit so that the material particles can fall into a receiving pocket.

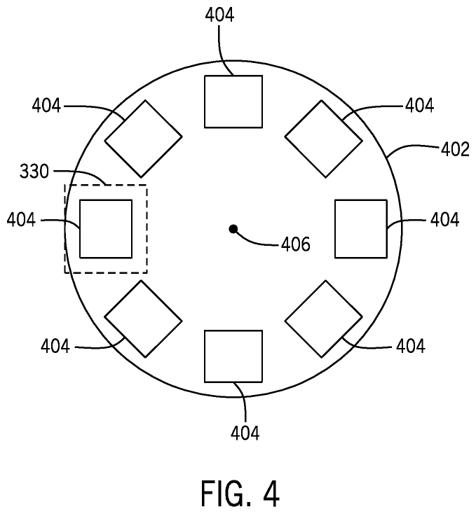

FIG. 5 is a block diagram of a 3D printing system 500 according to some examples. The 3D printing system 500 includes a flow conduit 504 that is defined by a housing 502 (e.g., a hopper) to flow a material between locations in the 3D printing system. The 3D printing system 500 further includes a controllable valve 506 to control gas communication to the flow conduit 504.

In addition, the 3D printing system 500 includes a pressure chamber 508 to receive pressurized gas at an elevated pressure while the controllable valve 506 is in a restricted flow position. A controller 510 intermittently actuates the controllable valve 506 to an open position to direct a burst of gas at the elevated pressure to the flow conduit 504 to disturb the material in the flow conduit. The controller 510 can intermittently actuate the valve 506 to the open position in response to an event, such as a pressure measurement from a pressure sensor, a passage of a predetermined time duration, or another event.

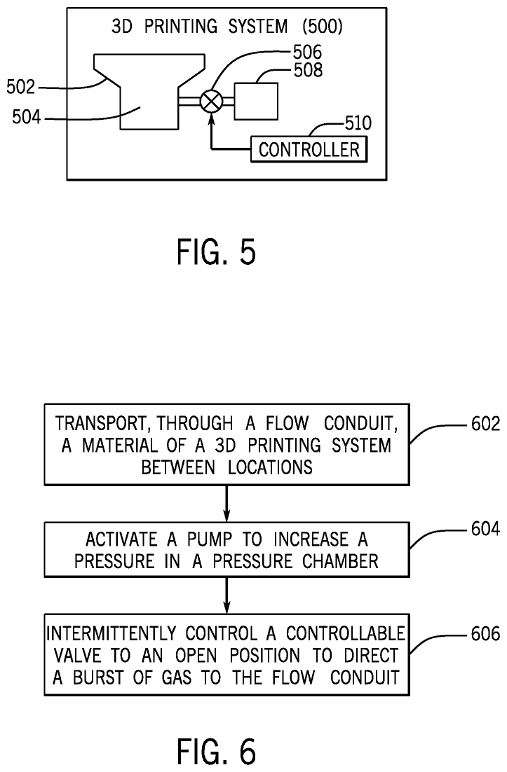

FIG. 6 is a flow diagram of an example process. The process of FIG. 6 includes transporting (at 602), through a flow conduit, a material of a 3D printing system between locations in the 3D printing system. The process activates (at 604) a pump to increase a pressure in a pressure chamber.

The process also includes intermittently controlling (at 606) a controllable valve to an open position, the controllable valve connected to an inlet port of the flow conduit, where the controllable valve when in the open position directs a burst of gas at an elevated pressure built up in the pressure chamber to the flow conduit to disturb the material in the flow conduit.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An apparatus comprising:
a flow conduit to transport a material between locations in a three-dimensional (3D) printing system;
a controllable valve to control gas communication to the flow conduit; and
a pressure chamber to receive an increase in pressure while the controllable valve is in a restricted flow position, and the controllable valve when actuated to an open position to direct a burst of gas at an elevated pressure built up in the pressure chamber to the flow conduit to disturb the material in the flow conduit.

2. The apparatus of claim 1, further comprising a pump to inject gas into the pressure chamber to increase the pressure in the pressure chamber.

3. The apparatus of claim 1, wherein the flow conduit is defined by a housing and comprises a gas inlet in the housing, the gas inlet in fluidic communication with the valve, the burst of gas to enter into the flow conduit through the gas inlet at an angle relative to an axial axis of the flow conduit.

4. The apparatus of claim 1, wherein the flow conduit is inside a hopper comprising an enlarged portion and a narrow portion.

5. The apparatus of claim 1, further comprising a gas-material separator to separate a gas from the material, the material separated from the gas to flow into the flow conduit.

6. The apparatus of claim 5, wherein the gas-material separator comprises a cyclone separator to direct flows of the gas and the material along spiral paths.

7. The apparatus of claim 1, further comprising a pressure sensor to measure a pressure of the pressure chamber, wherein the actuation of the controllable valve is responsive to the pressure measured by the pressure sensor.

8. The apparatus of claim 7, further comprising a controller to actuate the controllable valve to the open position responsive to a pressure in the pressure chamber exceeding a threshold.

9. The apparatus of claim 1, further comprising a controller to actuate the controllable valve to the open position responsive to an event.

10. The apparatus of claim 9, wherein the event comprises passage of a predetermined time duration.

11. The apparatus of claim 1, further comprising:
a moveable part comprising a pocket to receive the material from the flow conduit; and
a controller to:
detect a position of the pocket relative to the flow conduit as the moveable part move, and
actuate the controllable valve in response to the pocket moving to a predetermined position relative to the flow conduit.

12. A three-dimensional (3D) printing system comprising:
a flow conduit to flow a material between locations in the 3D printing system;
a controllable valve to control gas communication to the flow conduit;
a pressure chamber to receive pressurized gas at an elevated pressure while the controllable valve is in a restricted flow position; and
a controller to intermittently actuate the controllable valve to an open position to direct a burst of gas at the elevated pressure to the flow conduit to disturb the material in the flow conduit.

13. The 3D printing system of claim 12, further comprising a pressure sensor to measure a pressure in the pressure chamber, wherein the controller is to actuate the controllable valve to the open position in response to the measured pressure exceeding a predetermined threshold.

14. A method comprising:
transporting, through a flow conduit, a material of a three-dimensional (3D) printing system between locations in the 3D printing system;
activating a pump to increase a pressure in a pressure chamber; and
intermittently controlling a controllable valve to an open position, the controllable valve connected to an inlet port of the flow conduit, wherein the controllable valve when in the open position directs a burst of gas at an elevated pressure built up in the pressure chamber to the flow conduit to disturb the material in the flow conduit.

15. The method of claim 14, further comprising:
following the actuating of the controllable valve to the open position, controlling the controllable valve to a restricted flow position to allow an increase in pressure in the pressure chamber by the pump.
